(19) United States
(12) Patent Application Publication
(10) Pub. No.: US 2015/0244796 A1
(43) Pub. Date: Aug. 27, 2015

(54) Extensible Self-Service Terminal (SST) Server

(71) Applicant: NCR Corporation, Duluth, GA (US)

(72) Inventor: Ian M. Joy, Fife (GB)

(73) Assignee: NCR Corporation, Duluth, GA (US)

(21) Appl. No.: 14/192,079

(22) Filed: Feb. 27, 2014

(51) Int. Cl. H04L 29/08; G06Q 20/10; H04L 12/26; G06Q 20/18; G06F 9/455; H04W 12/06

(52) U.S. Cl. CPC H04L 67/1095; G06Q 40/02; G06F 9/45533; H04W 12/06; H04L 43/16; G06Q 20/18; G06Q 20/1085

(57) ABSTRACT

Methods and a system for an extensible Self-Service Terminal (SST) server are provided. A first Virtual Machine (VM) of a first SST cooperates with a second VM of a second SST to logically act as a local server within an establishment where the first SST and the second SST are situated. Each VM self-manages the local server as new VMs are added and other VMs are removed from participation within the local server. In an embodiment the local server includes: fault tolerance, failover processing, dynamic additions of VMs, and dynamic contraction by removal of some VMs from the local server.

### BACKGROUND

Increasingly retail establishments are being automated to take advantage of customer behavioral shifts and to streamline operational efficiency of their retail outlets. Consumers have adopted mobile technologies and are comfortable with conducting retail transactions utilizing a variety of Self-Service (SS) technologies.

In response, the retail industry has deployed a variety of Self-Service Terminals (SST) within their facilities to accommodate the consumers and provide yet another reason for the consumer to come to brick-and-mortar stores while the relentless online-store fronts continue to erode foot traffic for the retailers.

One industry in particular has capitalized on recent trends because foot traffic is fairly steady, is the banking industry.

Automated Teller Machine (ATM) security is a big concern to banks and their customers. As a result, transaction software (related to financial transactions occurring on the ATM) is very restrictive. To provide automated in-person services and other marketing opportunities (by way of ATM advertisements), banks have required very limited and highly secure and restrictive certification of any non-financial software residing on the ATM. But, in order to provide fast response times to staff devices, within the bank branch, from the local server, the local server typically has to be in close physical proximity to the ATMs and the teller devices. So, the local server has to be situated at the bank branch and near the devices being used.

To more fully provide automated customer-assistance while using the ATM at the bank branches, banks have permitted local secure servers that act as secure proxies to intercept some information being transmitted from the ATM within the bank branch for use by bank staff and to interact with the customers of the ATM via a small featured application that can communicate with the local secure server from the ATM.

The issue with this arrangement is that bank staff or contracted staff is needed to maintain the server. Plus, the server requires physical space, power consumption, hardware equipment and maintenance, software maintenance, and is subject to failure conditions. Banks would prefer to do away with these local servers because of the space and other issues that expend limited resources of the banks, but the feature of the local server permits the banks to provide quality service to their customers.

Furthermore, each ATM is powered up (in some case twenty-four hours a day) and made available to a customer. Therefore, the resources of the ATM and the power usage required to run the ATM are grossly underutilized because customer traffic is intermittent and rarely does a bank branch have a customer at each of the available ATMs for each hour that the bank branch is open for service.

### SUMMARY

In various embodiments, methods and a system for an extensible Self-Service Terminal (SST) server are presented.

According to an embodiment, a first Virtual Machine (VM) of a first SST and a second VM of a second SST are identified. Next, the first VM and the second VM are configured to cooperate as a local server within an establishment where the first SST and the second SST are situated. Finally, the local server is initiated for access within the establishment.

### BRIEF DESCRIPTION OF THE DRAWINGS

FIG. 1 is a diagram of an example architecture to establishing an extensible Self-Service Terminal (SST) server and for operation of that extensible server, according to an example embodiment.

FIG. 2 is a diagram of a method for extensible SST server operation, according to an example embodiment.

FIG. 3 is a diagram of another method for extensible SST server operation, according to an example embodiment.

FIG. 4 is a diagram of an extensible SST server system, according to an example embodiment.

### DETAILED DESCRIPTION

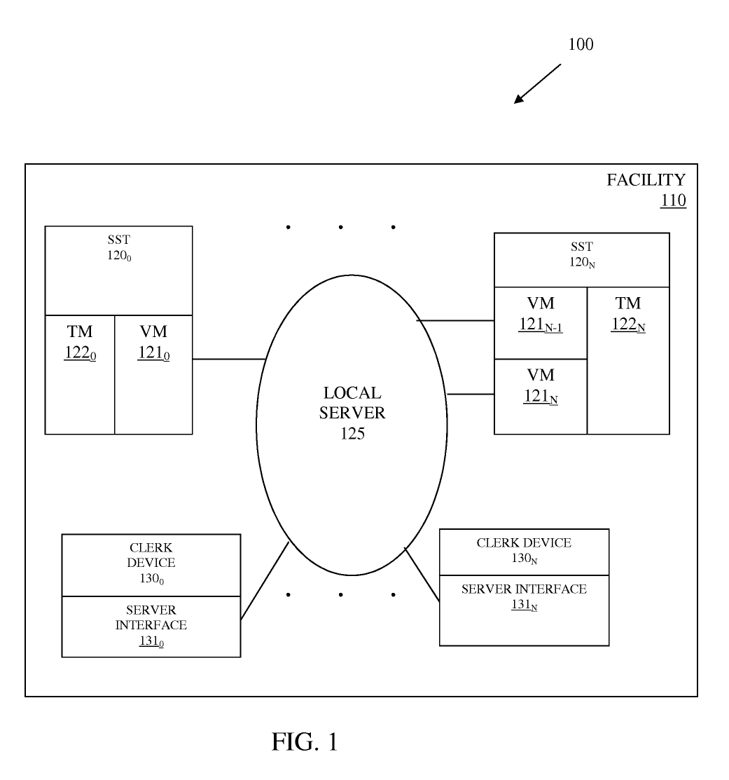

FIG. 1 is a diagram of an example architecture 100 to enable inter-device Self-Service Terminal (SST) interactions, according to an example embodiment. The various components are illustrated and the arrangement of the components is presented for purposes of illustration only. It is to be noted that other arrangements with more or less components are possible and foreseeable, without departing from the onsite automated customer assistance teachings presented herein and below.

The techniques, methods, and system presented herein and below for extensible SST server interactions can be implemented in whole or in part in one, all, or some combination of the components shown with the architecture 100. The techniques and methods are programmed as executable instructions in memory and/or non-transitory computer-readable storage media and processed on one or more processors associated with the various components.

The discussion of the architecture 100 is within the context of a banking facility (bank branch) for banking transactions being made in person and at Automated Teller Machines (ATMs). It is noted that the architecture 100 is also applicable to any enterprise providing SSTs and in-person customer assistance. Thus, the description that follows below is but one embodiment of the invention and it not intended to limit the invention to only financial transactions at financial facilities.

The example architecture 100 includes a bank branch 110, a plurality of Automated Teller Machines (ATMs) 120₀-120_{N}, a local server 125, and a plurality of mobile tablets 130₀-130_{N}. The ATMs 120₀-120_{N} (operated by customers), the local server 125, and the mobile tablets 130₀-130_{N} (operated by tellers) are situated within the bank branch 110. Each ATM 120₀-120_{N} includes one or more Virtual Machines (VMs) 121₀, 121_{N-1}, and 121_{N}, respectively, and a transaction machine 122₀ and 122_{N}, respectively. Each tablet 130₀-130_{N} includes its own server interface 131₀ and 131_{N}, respectively.

The bank branch 110 includes areas for customers to access the ATMs 120₀-120_{N} to perform self-service financial transactions with an external financial backend system (not shown in the FIG. 1) utilizing the transaction machines 122₀-122_{N} of the ATM 120₀-120_{N}. The bank branch 110 also includes teller stations for customers to walkup and to perform in-person transactions with tellers. One or more of the tellers are equipped with the tablets 130₀-130_{N}.

The transaction machines 122₀-122_{N} are secure partitions overlaid on the physical hardware of the ATMs 120₀-120_{N} for performing customer financial transaction. The transaction machines 120₀-120_{N} are physical and software-based processing environments having their own independent and secure version of an Operating System (OS) and dedicated memory, storage, and in some cases, processors from their respective ATMs 120₀-120_{N}.

The VMs 121₀-121_{N} are independent processing environments (having their own independent storage, memory, and, in some cases processors from their respective ATMs 120₀-120_{N}) from the transaction machines 122₀-122_{N} that are overlaid on top of a host OS (native OS) for the ATMs 120₀-120_{N} by way of a guest OS. Each VM 121₀-121_{N} includes hypervisor or VM Monitor (VMM—not shown in the FIG. 1) that manages each image of the VMs 121₀-121_{N} on a particular one of the ATMs 120₀-120_{N}. In an embodiment, an ATM 120_{N} can include more than one VM 121_{N-1} and VM 121_{N} (the second VM instance identified as 121_{N-1}). The VMM can also provide inter-VM communications and can communicate with other instances of the VMM through network communications (wired and/or wireless).

Intercommunications between the transaction machines (TMs) 122₀-122_{N} can occur in a variety of manners, such that an existing small secure application that executes on the ATMs 120₀-120_{N} within the TMs 122₀-122_{N} can communicate with other services/applications of the VMs 121₀-121_{N}. For example, the network communication port of the ATMs 120₀-120_{N} can be monitored by a small independent application running on the TMs 122₀-122_{N}, the VMs 121₀-121_{N}, or the host OS of the ATMs 120₀-120_{N} The purpose of this is to redirect (or “sniff out” as described below) the incoming and outgoing traffic for financial transactions occurring on the TMs 122₀-122_{N} to the VMs 121₀-121_{N}. Similarly, selective traffic from the VMs 121₀-121_{N} can be detected by a host OS app of the ATMs 120₀-120_{N} or can be routed by applications on the VMs 121₀-121_{N} to a communication port monitored by applications of the TMs 122₀-122_{N}. So, these are mechanisms that can be used to achieve intercommunications (two-way) between applications of the TMs 122₀-122_{N} and applications of the VMs 121₀-121_{N}. Another mechanism, could use shared storage locations or shared memory locations that both the TMs 122₀-122_{N} and the VMs 122₀-122_{N} can read and write to for two-way communications.

Such intercommunications, described above, ensure that conventional processing that banks use, within their bank branches, for secure communications (between customers transacting at the ATMs and tellers operating tablets within the bank branch) and occurring via an existing local server of the bank branch can run as normal with the improved logical local server 125 utilizing: a cluster configuration of the VMs 121₀-121_{N} processing on the ATMs 120₀-120_{N} and interacting with teller tablets 130₀-130_{N}; and passing through financial transactions occurring on the ATMs 120₀-120_{N} to the appropriate external financial systems (not shown in the FIG. 1).

It is noted that there are a number of mechanisms for existing financial transactions to reach and connect to external financial systems for servicing. The first is an approach where the VMs 121₀-121_{N} act as a proxy and pass through the communications from the ATMs 120₀-120_{N} to the external financial systems. The second mechanism is to permit the TMs 122₀-122_{N} to use their existing configuration to communicate with the external financial systems through the expected network communication port of the ATMs 120₀-120_{N}. For the second mechanism, the VMs 121₀-121_{N} can “sniff out” the traffic (as described above via a host OS application, VMM, or small application installed on the TMs 122₀-122_{N}) to provide tellers access to (and two-way communication with) some information regarding the financial transactions via the logical local server 125.

So, it is noted the technique of clustering cooperating independent instances of VMs 121₀-121_{N} to form a logical server 125 within a bank branch 110 can be accomplished in a manner that appears (transparent and seamless) to the tellers and the bank to be a conventional local server architecture. But, in fact, the VMs 121₀-121_{N} are the local server 125 and utilize existing hardware, memory, storage, network connectivity, network bandwidth, and power consumption of the bank's ATMs 120₀-120_{N}. One appreciates that this removes the equipment and power consumption associated with a bank's conventional local servers so as to: reduce space and expenses for such equipment, improve maintenance and support of the local server 125, and improve network efficiencies for the local server 125 (described below).

The tablets 130₀-130_{N} include server interfaces 131₀-131_{N} for communication with the local server 120. These interfaces 131₀-131_{N} provide a mechanism for the tellers to monitor and interact with, in real time, financial transactions of the bank branch when the tellers may or may not be assisting other customers conducting in-person transactions at teller stations of the tellers. The interfaces 131₀-131_{N} include processing for interacting with the local server 125 (via an Application Programming Interface (API) and include processing for interacting with the tellers via a Graphical User Interface (GUI) presented on one or more screens of displays associated with the tablets 130₀-130_{N}. The GUI can also permit metrics and operations associated with the overall processing of the local server 125 to be accessed and altered by an authorized teller (authenticated to the local server 125 as an administrator).

The server 125 is logically assembled from the VMs 120₀-120_{N}. That is, the VMs 120₀-120_{N} are configured to communicate and cooperate with one another to: delegate, assign, accept, confirm, and reject actions for processing between the VMs 120₀-120_{N}; communicate processing metrics; perform backup operations, identify fault conditions of some of the VMs participating in the local server 125; respond to operations requested by the server interfaces 131₀-131_{N}; and service the tablets 130₀-130_{N} by allowing sever sessions and providing access to resources controlled by the VMs 120₀-120_{N}. Such resources can include but are not limited to: storage, printers, memory, cameras, authentication services, messaging services, reporting services, backup and recovery services, and other custom services/applications required by the tellers at the bank branch 110.

Connection and resource access to the server 125 is presented to the server interfaces 131₀-131_{N} as one collective resource (which is the server 125). So, from the perspective of a teller operating one of the tablets 130₀-130_{N}, the server 125 is a single collective resource, but the server 125 is actually logical in nature, since it is a collection of cooperating independent VMs 120₀-120_{N}.

The presentation of the server 125, within the bank branch 110, permits hardware resources (memory, processor, network bandwidth, and storage) to be more fully utilized within the bank branch 110. Moreover, the server can eliminate existing hardware and equipment that traditional bank branches require to provide local server services within a traditional bank branch.

The features and interactions associated with some example operating scenarios of the architecture 100 are now presented for further illustration and comprehension.

Initially, a VM 121₀ is configured and its image captured. The configured image includes the features discussed above through one or more application services and resources (storage capacity, memory locations, available processors, network ports, authentication, connection, user-details, reporting, user-permitted operations, etc.) embedded (and programmed) within the image. That image is installed on ATM 120₀, then, an existing local server for the bank branch 110 is shut down and the VM 121₀ is initiated on the ATM 120₀ (perhaps via a VMM installed on the ATM 120₀, as discussed above).

These brings up the features discussed above and creates the local server 125 within the enterprise and permits a teller operating tablet 130₀ to authenticate (wirelessly) to the local server 125 as an authorized teller user and establish a communication session with the local server 125. Notice, in this example, the local server 125 is comprised of a single VM 121₀. Also notice that the remaining ATMs through 120₁ (implied by the ellipsis “. . . ” in the FIG. 1) through 120_{N} have not been modified at this point in time. Additionally, the server interface 131₀ of the teller may not even require modification from its old server interface used with the old server, which is now shut down. This is so because the old features that the old server interface used to interact with the old local server can be mirrored in the configured image of the VM 121₀, which is now running on the ATM 120₀. Additionally, the old IP address assigned for connecting to the old local server can be detected by the VM 121₀; so, at this point only the ATM 120₀ has been modified. Of course, for this to work the ATM 120₀ has to recognize the wireless traffic on a wireless network. A variety of techniques can be used to achieve this. For example, a wireless access point that captures wireless signals within the bank branch 120 can be installed having a wired Ethernet port that connects the wireless access point to the networked ATMs 120₀-120_{N} as they previously existed for the old server. Another mechanism could be to equip at least one ATM 120₀-120_{N} with a wireless adapter (as described above) or a wireless network card (where just the VM 121₀ has access to the wireless port associated with the wireless network card to prevent unauthorized sniffing of the TM 122₀) and that interfaced ATM 120₀ communicates and detects traffic through the existing network connections between the ATMs 120₀-120_{N}. It is noted that a variety of mechanisms can be used to permit wireless and wired traffic to be detected by the VMs 120₀-120_{N} and the above discussion was presented to illustrate how some configurations can be done with minimal effort by a bank branch.

Suppose now a customer approaches the ATM 120_{N} and scans an image of a check for deposit during a financial transaction with TM 122_{N}. The Internet Protocol (IP) address of the old local server for the bank branch can be recognized by the VM 121₀ (VM 121₀ configured this way in the image to grab traffic from the other VMs 121₁-121_{N} having the old IP address of the old local server) for processing. In this way, only ATM 120₀ has been changed in the bank branch 110 and the old server powered down and the local server 125 is up and running (and as discussed above the wireless connectivity (direct (wireless card) or indirect (wireless access point with Ethernet wired connection)) to the ATM 120₀ is created through a number of available approaches some of which were discussed above).

The check image can be wirelessly presented on the GUI portion of the server interface 131₀ to the teller logged into the local server 125. The ATM 120_{N}, using its existing configuration, sends the check image to what it believes is the old server though its existing network connection, which is picked up and processed by the VM 121₀ now acting as local server 125. VM 121₀ performs the processing of the old server to forward details of transaction sniffed from TM 122N to the external backend financial system for processing and acquires the check image that it sends wirelessly to the table 130₀ (using the same mechanism to transmit as the old server as what was described above to receive wireless communication).

Since, the ATM 120₀ and the tablet 130₀ are in relatively close proximity to one another within the bank branch 110 (usually within a few feet of the teller stations and within eye sight of the teller); the network reception of the transmission is received quickly by the teller. The quality and rate of a wireless signal also degrades as the distance between the source of the transmission and the receiver of the transmission increases. So, the teller experiences a faster and better quality transmission from the local server 125 from that which existed in prior bank branch server configurations. This is especially true for transmissions having a large amount of transferred data, such as image data (the transferred check image).

Any previously provided feature of the old server within the bank branch 110 and the server interface 131₀ can be replicated in the programming of the VM 121₀, which is acting as the new local server 125 for the bank branch in the above-presented example; these features can include previous server metrics and operations that existed in the previous server interface (now in server interface 131₀) of tablet 130₀.

In addition, the image of the VM 121₀ and each image of additional added VMs 121₁-121_{N} can be configured to include programming and services, such that the local server 125 can self-manage itself to provide operations for: backing up, mirroring, rebooting (just the VMs 121₀-120_{N} and not TMs 122₀-122_{N}), expanding to include new VMs, contracting to remove a particular VM, and the like.

For example, suppose in the example operating scenario of the architecture 100 that VM 121_{N-1} is imaged and initiated on ATM 120_{N} (using the same approach discussed in detail above). VM 121_{N-1} is configured to publish its available on the ATM network, which VM 121₀ recognizes. The two VMS 121₀ and 121_{N-1} then self-configure themselves to manage, assign, delegate, and process traffic on local server 125. Now, the bank branch 110 is using resources of two ATMs 120₀ and 120_{N} to act as logical server 125.

Each VM 121₀ and 121_{N-1} can also periodically report status and metrics about processing load, fault conditions (fault tolerance), operations processing, memory and storage capacity and the like. This allows for one to go offline while the other remains online (by migrating traffic from the one going offline to the one online) and allows for load balancing. Traffic requests can also be mirrored between the VMs 121₀ and 121_{N-1}; this permits one to detect another is unresponsive and handle any unprocessed transactions that were being handled by the unresponsive one. Each of the VM 121₀ and 121_{N-1} can also force a reboot of the entire local server 125 (which is initiated from within the ATMs 120₀ and 120_{N-1} from the VMs 121₀ and/or 121_{N-1}, and such has never been capable from existing technologies). In fact, any normal server based: error processing, logging, reporting, error recovery, and/or auditing can be achieved via configuration and cooperation between the two VMs 121₀ and 121_{N-1} acting in concert with one another as a single logical server 125.

One now appreciates how a bank branch 110 can maximize existing equipment (ATM 120₀-120_{N}) and that equipment's resources to eliminate conventional server equipment from the bank branch 110. Moreover, it is appreciated that the embodiments, discussed herein, can improve network response time of a novel local server 125 within the bank branch 110. These advantageous features are accomplished by creating and configuring cooperative VMs 121₀-121_{N} on the ATMs 120₀-120_{N} to logically present and provide access to a local server 125 within the bank branch 110. Moreover, the local server 125 can include a single VM 121₀ or multiple VMs 121₀-121_{N} that act as the local server 125. Also, a single ATM 120_{N} can include multiple VMs 121_{N-1}-121_{N} cooperating in the local server configuration. Furthermore, the local server 125 can self-grow, self-expand, and self-manage itself.

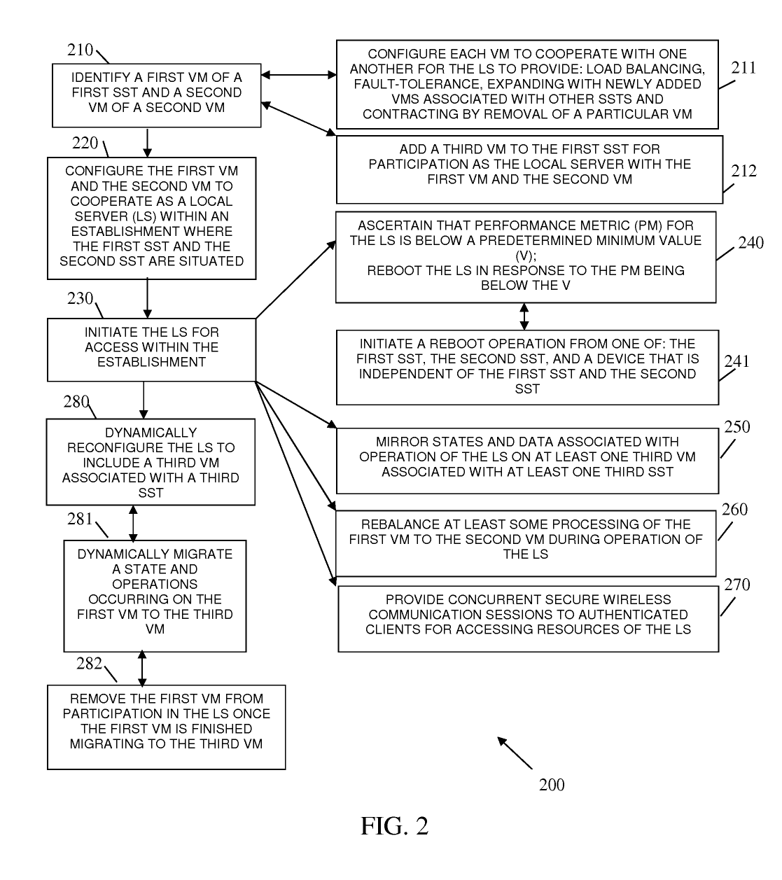

These (above-discussed) embodiments and other embodiments are now discussed with reference to the FIGS. 2-4.

FIG. 2 is a diagram of a method 200 for extensible SST server operation, according to an example embodiment. The software module(s) that implements the method 200 is referred to as a “SST-server manager.” The SST-server manager is implemented as executable instructions programmed and residing within memory and/or a non-transitory computer-readable (processor-readable) storage medium and executed by one or more processors of one or more devices. The processors of the device(s) that executes the SST-server manager are specifically configured and programmed to process the SST-server manager. The SST-server manager has access to one or more networks during its processing. The networks can be wired, wireless, or a combination of wired and wireless.

In an embodiment, the device(s) that processes the SST-server manager is programmed within and operational from one or more of the ATMs 120₀-120_{N} (as one more cooperating instances of the SST-assistance manager). In this embodiment, SST-server manager can include one or more cooperating instances of the VMs 121₀-120_{N} and, optionally, one or more instances of VMMs (hypervisors) operational on each of the ATMs 120₀-120_{N}.

In another embodiment, the device(s) that processes the 120₀-120_{N} are kiosk(s) situated on the premises of a retail establishment where customers can conduct self-service transactions at the kiosk(s) and also conduct in-person transactions with clerks of the establishment, the clerks having access to clerk devices, such as clerk devices 130₀-130_{N}. The clerk devices can be tablets (discussed with the embodiments of the FIG. 1), wearable processing devices (Google Glass™), laptops, smartphones, and the like. The kiosks can be ATMs (discussed with the embodiments of the FIG. 1 or any other retail self-service device (e.g., self-service grocery checkout stations, entertainment kiosks, vending machines with processing capabilities, and the like).

At 210, the SST-server manager identifies a first VM of a first SST and a second VM of a second SST. The first and second SSTs are the devices that are executing cooperating instances of the SST-server manager.

The perspective of the processing for the SST-server manager can be considered to be from one of the SSTs with the other SST having another instance of the SST-server manager. Again, it may also be that the SST-server manager is a VMM on one of the SSTs or that the SST-server manager is a combined featured software module including some features of a VMM on one of the SSTs. Still further, the SST-server manager can be associated with an entirely different SST from the first and second SSTs and networked (as discussed above with the discussion of the FIG. 1) with the first and second SSTs.

According to an embodiment, at 211, the SST-server manager configures each VM to cooperate with one another as a local server (discussed below). The first and second VMs cooperate with one another for the local server to provide: load balancing, fault-checking (fault tolerance), expanding with newly added VMs associated with other SSTs, and contracting by removal a particular VM from participation in the logical local server.

In an embodiment, at 212, the SST-server manager adds a third VM to the first SST for participation as the logical local server with the first and second VMs. This was discussed above with reference to the FIG. 1 and identified in FIG. 1 as VMs 121_{N-1} and 121_{N}.

At 220, the SST-server manager configures the first VM and the second VM to cooperate as a logical local server within an establishment (physical storefront or site) where the first SST and the second SST are situated. The logical local server can be interacted with, identified, and referenced by a single identifier, such as a name—for instance “store-server,” and/or an Internet Protocol (IP) address.

At 230, the SST-server manager initiates the local server for access within the establishment. Any local server access can be secure, by requiring secure protocols (encrypted data transmissions) or by requiring insecure protocols (unencrypted data transmissions) that have data encrypted by the transmitting applications before being exposed over the insecure protocols. In some cases for added security, the data being sent is custom encrypted (using public-private key pairs) before being injected over the network transmission and that custom-encrypted data is further encrypted and transmitted using a secure protocol.

According to an embodiment, at 240, the SST-server manager ascertains that a performance metric for the local server is below a predetermined minimum value, which causes the SST-server manager to be rebooted. The reboot affecting just the VMs of the corresponding SSTs on which they reside and does not affect other logical machines executing in their own independent processing environments on those SSTs.

In an embodiment of 240 and at 241, the SST-server manager initiates the reboot operation one of: the first SST, the second SST, and a device independent of the first SST and the second SST (here the SST-server manager may or may not be processing on the first SST or the second SST; for example, the SST-server manager is processing on a different SST networked with the first and second SSTs). It should also be noted that the SST-server manager is responsible for initiating the reboot operation but the reboot instruction can come from a device that is interfaced to the local server but not part of the local server, such as when a clerk having a mobile device and administrative access to the local server sends the reboot instruction that the SST-server manager is responsible for initiating.

According to an embodiment, at 250, the SST-server manager mirror states and data associated with operation of the local server on at least one third VM associated with at least one third SST. This provides for failover support in the event that the entire local server (first and second VMs) encounters a fatal error that hangs the local server and provides backup features for the local server. So, if the local server hangs and becomes unresponsive, the third VM can pick up processing as the local server while the first and second VMs are rebooted or rectified. This provides High Availability (HA) for access and availability of the local server. The fault tolerance of the local server, provided herein, is something that a conventional ATM local server cannot achieve because it is located onsite of a bank branch as a single-centralized device having a single point of failure.

In some cases of the previous embodiment, the mirroring or replication occurs between the first and second VMs, such that if one becomes unresponsive, the other can temporarily act by itself as the local server to provide HA.

In an embodiment, at 260, the SST-server manager rebalances at least some processing of the first VM to the second VM during operation of the local server. For example, the second VM may report to the first VM that memory or processor usage of the second VM is nearing capacity or is approach a defined unacceptable threshold. In response, to this, traffic for the local server is redirected from the second VM to the first VM and, perhaps, some pending transactions of the second VM, which are queued for processing, are transferred for execution to the first VM. So, the local server can load balance to optimize operational efficiency of the logical local server.

In an embodiment, at 270, the SST-server manager provides concurrent secure wireless communication session to authenticated clients for accessing resources and services of the logical local server. For example, clerks operating mobile devices having a local server interface can log onto the server and perform server operations based on their level of access to those operations (as determined from authenticated logins and credentials provided by those clerks).

According to an embodiment, at 280, the SST-server manager dynamically reconfigures the local server to include a new third VM associated with a third SST. This was described above with reference to the example scenario of the FIG. 1. This illustrates that the SST-based logical local server is extensible and can grow automatically and without manual intervention.

In an embodiment of 280 and at 281, the SST-server manager dynamically migrates a state and operations occurring on the first VM to the third VM. This gradually brings the third VM up to speed and in synch with the local server so that the third VM is fully functional and a beneficial resource to the local server.

In an embodiment of 281 and at 282, the SST-server manager dynamically removes the first VM from participation in the local server once the first VM is finished migrating to the third VM. Here, the first VM may be scheduled to be taken offline and out of participation from the local server; so, the migration of 281 was done to prepare a backup VM (third VM) for the eventual removal of the first VM from the local server.

One now appreciates how existing hardware, network, and power resources of SSTs can cooperate to form a local server accessible to other enterprise devices within an establishment of an enterprise. This utilizes assets more efficiently, since in many cases assets of SSTs are grossly underutilized and eliminates the need for equipment and power associated with maintaining a separate set of equipment to provide a local server at the establishment. Moreover, the SST-based server is automated and extensible, since the SST-based server can self-manage, self-expand, and self-contract without any manual intervention.

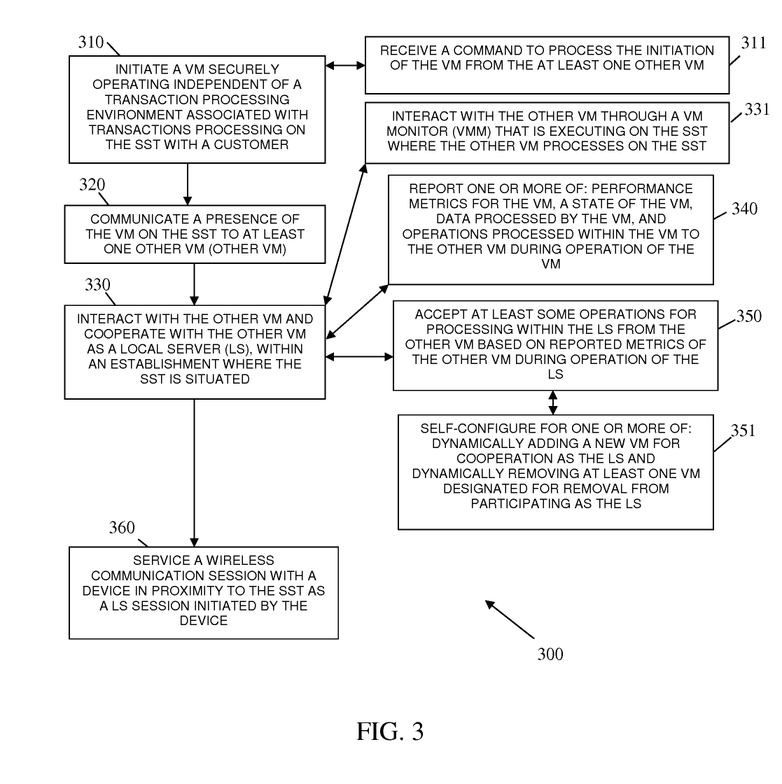

FIG. 3 is a diagram of another method 300 for extensible SST server operation, according to an example embodiment. The software module(s) that implement the method 300 is referred to herein as a VM-server agent. The VM-server agent is implemented as executable instructions and programmed within memory and/or a non-transitory computer-readable (processor-readable) storage medium that executes on one or more processors of a SST. The processors of the SST are specifically configured to execute the VM-server agent. The VM-server agent can access one or more networks; the networks can be wired, wireless, or a combination of wired and wireless.

In an embodiment, the SST that processes the VM-server agent is one of the ATMs 120₀-120_{N} of the FIG. 1.

In an embodiment, VM-server agent is implemented as an enhancement to the method 200 of the FIG. 2.

At 310, the VM-server agent initiates a VM, which is securely operating independent of a transaction processing environment associate with transactions processing on the SST with a customer. So, the SST that processes the VM-server agent is also partitioned to process an independent machine, such as what was described above with reference to the TMs 122₀-122_{N} of the FIG. 1.

According to an embodiment, at 311, the VM-server agent receives a command to process the initiation of the VM from at least one other VM. Here, the configured VM is ready for initiation but relies on another VM for the command for the VM to start execution. The other VM can be on the same SST as the VM-server agent or can be on a different SST networked (as discussed above) to the SST that is processing the VM-server agent.

At 320, the VM communicates a presence of the VM on the SST to at least one other VM. Again, the other VM can be on the same SST as the VM or can be on a different SST networked to the SST of the VM. This publishes the availability of the VM to other VMs that are in network communication with one another already.

At 330, the VM interacts with the other VM to cooperate with the other VM as a logical local server within an establishment where the SST is situated (and other SSTs, if the at least one other VM is operating on a different SST from the VM).

According to an embodiment, at 331, the VM interacts with the other VM through a VMM that is executing on the SST where the other VM also executes on the same SST as the VM.

It may also be the case, at 331, that the VM interacts with its own VMM and the at least one other VM interacts with other operating instances of the VMM, which execute on a separate SST(s) for the at least one other VM.

According to an embodiment, at 340, the VM reports to the at least one other VM (during operation of the local server) one or more of: metrics for the VM, a state of the VM, data processed by the VM, and operations processed within the VM.

In an embodiment, at 350, the VM accepts some operations for processing within the local service processing environment from the other VM based on reported metrics of the other VM. Here, the VM is taking processing away from the other VM to load balance network processing on the logical local server.

According to an embodiment of 350 and at 351, the VM self-configures for one or more of: dynamically adding a new VM for cooperation as the local server, can dynamically removing at least one VM designated for removal from participating as the local server. Thus, the SST-based server is extensible by self-growing and self-contracting in an automated fashion and without any manual intervention.

In an embodiment, at 360, the VM services a wireless communication session with a device in proximity to the SST (of the VM) as a local server session, which is initiated by the device; for example, a clerk device 130₀-130_{N}. Such wireless communication session can also improve network transmission quality and response times experienced by the clerk devices because the clerk is in closer physical proximity to the SSTs, which are acting as the local server (conventional local servers are stored in hidden locations and usually at greater distances from the work areas of the clerks and the SSTs so wireless network transmissions have poorer quality and degraded transmission rates).

One now appreciates how an SST-based extensible server can be established and managed in an automated fashion within an establishment utilizing existing resources of SSTs, without interfering with ongoing customer-based SST transactions.

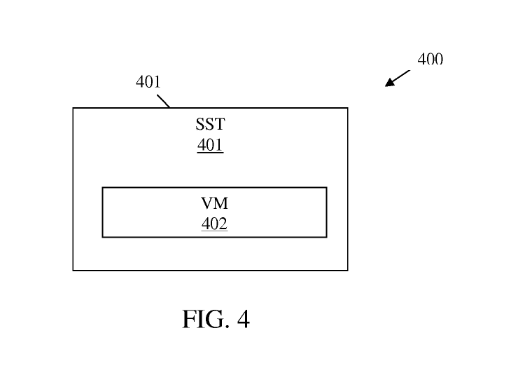

FIG. 4 is a diagram of an extensible SST server system 400, according to an example embodiment. The components of the extensible SST server system 400 are programmed and reside within memory and/or a non-transitory computer-readable medium and execute on one or more processors of a SST 401. The extensible SST server system 400 has access and can communicate over one or more networks; and the networks can be wired, wireless, or a combination of wired and wireless.

The extensible SST server system 400 includes a SST 401 and a VM 402 (software module or set of modules) that execute as executable instructions on one or more processes of the SST 401. The executable instructions reside in memory and/or a non-transitory computer-readable storage medium accessible to the SST 401.

In an embodiment, the VM 402 is an instance of one of the VMs 121₀-121_{N}.

In an embodiment, the VM 402 is the method 200.

In an embodiment, the VM 402 is the method 300.

The SST 401 is programmed with the VM 402. The VM 402 is operable to execute on the SST and cooperate with at least one other VM to form a local server within an establishment where the SST is situated.

According to an embodiment, the VM is further operable to: report metrics, state, and activities to the at least one other VM during operation of the local server, permit secure authenticated session associated with the local server to the VM, reconfigure to permit a new VM to cooperate as the local server, and reconfigure to remove a particular VM from cooperation as the local server.

In an embodiment, the at least one other VM is on the SST 401.

In an embodiment, the at least one other VM is on second and different SSTs from the SST 401.

It should be appreciated that where software is described in a particular form (such as a component or module) this is merely to aid understanding and is not intended to limit how software that implements those functions may be architected or structured. For example, modules may be illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors of a single device, or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
identifying, by a processor, a first Virtual Machine (VM) of a first Self-Service Terminal (SST) and a second VM of a second SST;
configuring, by the processor, the first VM and the second VM to cooperate as a local server within an establishment where the first SST and the second SST are situated; and
initiating, by the processor, the local server for access within the establishment.

2. The method of claim 1 further comprising:
ascertaining, by the processor, that a performance metric of the local server is below a predetermined minimum value; and
rebooting, by the processor, the local server in response to the performance metric being below the predetermined minimum value.

3. The method of claim 2, wherein rebooting further includes initiating a reboot operation from one of: the first SST, the second SST, and a device independent of the first SST and the second SST.

4. The method of claim 1 further comprising, mirroring, by the processor, states and data associated with operation of the local server on at least one third VM associated with at least one third SST.

5. The method of claim 1 further comprising, rebalancing, by the processor, at least some processing of the first VM to the second VM during operation of the local server.

6. The method of claim 1 further comprising, providing, by the processor, concurrent secure wireless communication sessions to authenticated clients for accessing resources of the local server.

7. The method of claim 1 further comprising, dynamically reconfiguring, by the processor, the local server to include a third VM associated with a third SST.

8. The method of claim 7, wherein dynamically reconfiguring further includes dynamically migrating a state and operations occurring on the first VM to the third VM.

9. The method of claim 8, wherein dynamically migrating further includes removing the first VM from participation in the local server once the first VM is finished migrating to the third VM.

10. The method of claim 1, wherein configuring further includes configuring each of the VMs to cooperate with one another for the local server to provide: load balancing, fault tolerance, expanding with newly added VMs associated with other SSTs, and contracting by removal of a particular VM.

11. The method of claim 1, wherein configuring further includes adding a third VM to the first SST for participation as the local server with the first VM and the second VM.

12. A method, comprising:
initiating, by a Self-Service Terminal (SST), a virtual machine (VM) securely operating independent of a transaction processing environment associated with transactions processing on the SST with a customer;
communicating, by the VM, a presence of the VM on the SST to at least one other VM; and
interacting, by the VM, with the at least one other VM to cooperate with that at least one other VM as a local server within an establishment where the SST is situated.

13. The method of claim 12 further comprising, reporting, by the VM one or more of: performance metrics for the VM, a state of the VM, data processed by the VM, and operations processed within the VM to the at least one other VM during operation of the local server.

14. The method of claim 12 further comprising, accepting, by the VM, at least some operations for processing within the local server from the at least one other VM based on reported metrics of the at least one other VM during operation of the local server.

15. The method of claim 13 further comprising, self-configuring, by the VM, for one or more of: dynamically adding a new VM for cooperation as the local server and dynamically removing at least one VM designated for removal from participating as the local server.

16. The method of claim 12 further comprising, servicing, by the VM, a wireless communication session with a device in proximity to the SST as a local server session initiated by the device.

17. The method of claim 12, wherein initiating further includes receiving a command to process the initiation of the VM from the at least one other VM.

18. The method of claim 12, wherein interacting further includes interacting with the at least one other VM though a VM Monitor (VMM) executing on the SST, the at least one other VM processing on the SST.

19. A system, comprising:
a Self-Service Terminal; and
a Virtual Machine (VM) operable to (i) execute on the SST and (ii) cooperate with at least one other VM to form a local server within an establishment where the SST is situated.

20. The system of claim 19, wherein the VM is further operable to: (iii) report metrics, state, and activities to the at least one other VM during operation of the local server, (iv) permit secure authentication sessions associated with the local server to the VM, (v) reconfigure to permit a new VM to cooperate as the local server, and (vi) reconfigure to remove a particular VM from cooperation as the local server.
